(19) United States
(12) Patent Application Publication
(10) Pub. No.: US 2023/0035455 A1
(43) Pub. Date: Feb. 2, 2023

(54) APPARATUS FOR INKJET PRINTING AND CURING INTEGRATION PROCESS

(71) Applicants: FUYU PRECISION COMPONENT(KUNSHAN)CO.,LTD., Suzhou (CN); Foxconn Technology Co., Ltd., New Taipei (TW)

(72) Inventors: HUNG-CHUN MA, New Taipei (TW); CHING-SHENG SUN, New Taipei (TW); FUH-FENG TANG, New Taipei (TW)

(21) Appl. No.: 17/825,088

(22) Filed: May 26, 2022

(30) Foreign Application Priority Data
Jul. 29, 2021 (CN) 202110864730.6

(51) Int. Cl. B41J 11/00; B41J 2/11

(52) U.S. Cl. CPC B41J 11/00214; B41J 2/11; B41J 11/0045

(57) ABSTRACT

An apparatus for inkjet printing and curing process for performing on more than one side of a workpiece in one continuous sequential process, the workpiece is shaped as a cube configured with a first surface, a second surface opposite to the first surface, and side surfaces connected between the first surface and the second surface. The apparatus for inkjet printing and curing integration process comprises a base, a supporting module, a printing module, a rotary module, and a transporting module, wherein the transporting module moves the workpiece under the printing module for being printed and cured on one side, then the rotary module rotates the workpiece such that a different side is presented for inkjet printing and curing. The printing module thus performs a continuous inkjet printing and curing process on more than one side of a workpiece, and the working efficiency is improved.

### CROSS-REFERENCE TO RELATED APPLICATIONS

This application claims priority to China Application No. 202110864730.6, having a filing date of Jul. 29, 2021, filed in China State Intellectual Property Administration, the entire contents of which is hereby incorporate by reference.

### FIELD

The subject matter relates to inkjet printing and ink-curing technologies, and more particularly, to an apparatus for inkjet printing and curing integration process.

### BACKGROUND

Inkjet printing on surfaces of workpieces, such as the shell of the electronic equipment, is generally carried out one side at a time, that is, the ink is applied to one side of the workpiece and then cured, and the workpiece is turned over, for printing and then curing of the other side of the workpiece.

However, such inkjet printing and curing operation is discontinuous for different sides of the workpieces, which reduces the working efficiency.

### SUMMARY

An objective of the present disclosure is achieved by providing an apparatus for inkjet printing and curing integration process for printing on a workpiece, which performs a continuous inkjet printing and curing process on more than one side of a workpiece and improves the working efficiency.

In order to achieve the purpose, technical solutions adopted by the present disclosure are as follows:

An aspect of the present disclosure provides an apparatus for inkjet printing and curing integration process for printing on a workpiece, the workpiece is shaped as a cube configured with a first surface, a second surface opposite to the first surface, and more than one side surfaces connected between the first surface and the second surface;
the apparatus for inkjet printing and curing integration process comprises:
   a base,
   a supporting module arranged on the base,
   a printing module mounted on the supporting module, the printing module slides on the supporting module along a X axis, sprays ink along a Z axis on the second surface and the side surfaces of the workpiece, and cures the ink sprayed on the workpiece,
   a rotary module positioned relative to the printing module, the rotary module is configured for rotating the workpiece to present more than one side of the workpiece to face the printing module between the second surface and the side surfaces; and
   a transporting module arranged on the base, the transporting module moves along the X axis and a Y axis, the rotary module is connected to the transporting module for moving with it; wherein
   each two of the X axis, the Y axis, and the Z axis are perpendicular to each other.
Preferably, the supporting module comprises
   a frame mounted on the base;
   a guider provided on the frame, the guider extends along the X axis; and
   a first driver connected to the guider; wherein
   the printing module is connected to the guider for being driven by the first driver to move along the guider.
Preferably, the printing module comprises
   a second driver connected to the guider;
   a printing element connected to the second driver, for spraying ink on the second surface and the side surface of the workpiece;
   a curing device connected to the second driver, for curing the ink on the workpiece; wherein
   the second driver drives the printing element and the curing device to move along the Z axis.
Preferably, the printing element comprises
   a plurality of inkjet heads, each inkjet head is used for spraying ink of one color;
   a plurality of control valves, each of the control valves is connected to one of the inkjet heads for controlling the spray time and the spray quantity of the connected inkjet head, to coat the second surface or the side surface with gradient.
Preferably, the apparatus for inkjet printing and curing integration process further comprises
   a calibrator configured for acquiring image of the workpiece, the calibrator is electrically connected to the second driver and the first driver for actuating the second driver and the first driver according to the acquired image.
Preferably, the rotary module comprises
   a supporting base;
   a first rotating member arranged on the supporting base; and
   a second rotating member configured for attaching the workpiece by vacuum-attraction of the first surface, wherein
   the first rotating member is connected to the second rotating member for rotating the second rotating member and the workpiece thereon around the X axis, the second rotating member is configured for rotating the workpiece around the Y axis.
Preferably, the second rotating member comprises
   a motor and a suction element connected to the motor, wherein
   the suction element is connected to the motor for creating a vacuum for attaching and rotating the attached workpiece, the second rotating member is connected to the first rotating member through the motor.
Preferably, the transporting module comprises:
   a third driver and a fourth driver arranged on the base, the supporting base is mounted on the third driver for being driven to move along the X axis, the third driver is arranged on the fourth driver for being driven to move along the Y axis.
Preferably, the apparatus further comprises
   a shell configured for receiving the supporting module and the printing module, the shell is arranged on the base and is configured with an opening for passage of the workpiece.
Preferably, the apparatus for inkjet printing and curing integration process further comprises
   a displayer arranged on the shell, the displayer is connected to the printing module the rotary module, and the transporting module for displaying processing information of the workpiece; and
   a signal light connected to the printing module, the rotary module, and the transporting module for indicating processing phase of the workpiece.

In operation, the transporting module moves the workpiece to be under the printing module for being printed and cured on one side, then the rotary module rotates the workpiece such that the side facing the printing module is switched and the printing module can operate on another side of the workpiece. Thereby, the printing module can perform a continuous inkjet printing and curing process on more than one side of a workpiece, and the working efficiency is improved.

Preferably, the apparatus for inkjet printing and curing integration process can be used for printing on magnesium alloys, such as wrought magnesium alloys, die casting magnesium alloys, and magnesium alloys made from other methods.

It should be noted that, the apparatus can be used for performing inkjet printing and curing integration process on other materials than magnesium alloy, such as aluminum alloys, glasses, or any other material suitable for shells of electronical devices.

### BRIEF DESCRIPTION OF THE DRAWINGS

Implementations of the present technology will now be described, by way of example only, with reference to the attached figures.

FIG. 1 is a schematic view of an example workpiece according to an embodiment of the present disclosure.

FIG. 2 is a schematic view of the workpiece and an apparatus for inkjet printing and curing process according to an embodiment of the present disclosure.

FIG. 3 is a schematic view of a rotatory module, a transporting module, and the workpiece according to an embodiment of the present disclosure.

FIG. 4 is a schematic view of a workpiece and an apparatus for inkjet printing and curing process according to an embodiment of the present disclosure.

### DETAILED DESCRIPTION

It will be appreciated that for simplicity and clarity of illustration, where appropriate, reference numerals have been repeated among the different figures to indicate corresponding or analogous components. The description is not to be considered as limiting the scope of the embodiments described herein. The drawings are not necessarily to scale and the proportions of certain parts may be exaggerated to better illustrate details and features of the present disclosure.

It should be understood that, the terms “first” and “second” are used to distinguish elements and are not used to denote a particular order or imply a number of technical features, therefore, unless being specifically defined, features described as “first” and “second” may expressly or implicitly include one or more of the stated features. In the description of the present application, “plurality” means two or more, unless otherwise expressly and specifically defined.

In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described.

The term “comprising,” when utilized, means “including, but not necessarily limited to”; it specifically indicates open-ended inclusion or membership in the so-described combination, group, series, and the like.

In order to achieve the purpose, an apparatus for inkjet printing and curing integration process is provided, the apparatus comprises a base, a supporting module, a printing module, a rotary module, and a transporting module, the workpiece is shaped as a cube configured with a first surface, a second surface opposite to the first surface, and side surfaces connecting the first surface and the second surface, the transporting module moves the workpiece to be under the printing module for being printed and cured on one side, then the rotary module rotates the workpiece such that a different side is presented for inkjet printing and curing. Thereby, the printing module can perform a continuous inkjet printing and curing process on more than one side of a workpiece, and the working efficiency is improved. In operation, the workpiece can be a shell or housing of a mobile phone, a pad, a notebook or any other electronic device, the ink supplied to the printer is tinted and can be cured by UV

A detailed description of the hereinafter described embodiments of the disclosure are presented herein by way of exemplification and not limitation with reference to the Figures.

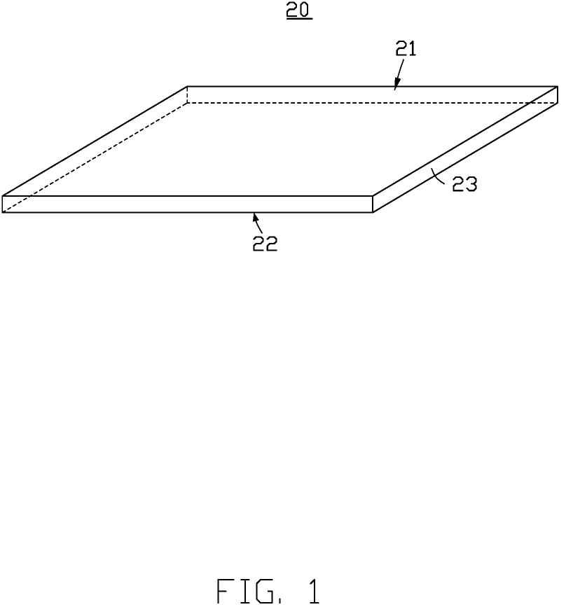

Referring to FIG. 1, a workpiece 20 is shown, the workpiece 20 is made of die casting magnesium alloy and substantially cube shaped, and is configured with a first surface 21, a second surface 22 opposite to the first surface 21, and four side surfaces 23 connected between the first surface 21 and the second surface 22. It should be noted that, the workpiece 20 can be arranged with more or less than four side surfaces.

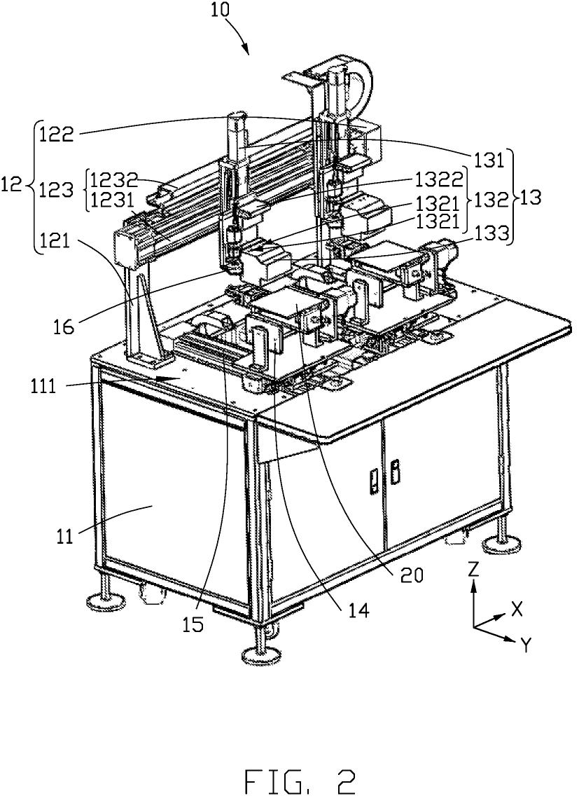

Referring to FIG. 2, an apparatus for inkjet printing and curing integration process 10 is provided, the apparatus 10 comprises a base 11, a supporting module 12, a printing module 13, a rotary module 14, and a transporting module 15, wherein the supporting module 12 is supported on the base 11, the printing module 13 is mounted on the supporting module 12 and slides on the supporting module 12 along a first direction, for spraying inks in a second direction on the second surface 22 and the side surface 23 of the workpiece 20 and curing the ink printed on the workpiece 20, the rotary module 14 is positioned relative to the printing module 13 and is configured for supporting the workpiece 20 by the first surface 21. In particular, the printing module 13 is positioned above the rotary module 14. The rotary module 14 is configured for rotating the workpiece 20, therefore the side of the workpiece 20 facing the printing module 13 switches between the second surface 22 and the side surfaces 23. The transporting module 15 is arranged on the base 11 and moves in the first direction and a third direction, the rotary module 14 is connected to the transporting module 15 for moving with it, wherein each two of the first direction, the second direction, and the third direction are perpendicular to each other.

It should be noted that, the term “first direction” means the extension direction of the guide rail 1231, that is the direction of the X axis shown in FIG. 2, the term “second direction” means direction of the Z axis shown in FIG. 2, and the term “third direction” means the extension direction of the second rail 1521, that is direction of the Y axis shown in FIG. 2.

In operation, the transporting module 15 moves the workpiece 20 into spray range of the printing module 13, then the printing module 13 sprays ink on the second surface 22 or the side surface 23 of the workpiece 20 and cures the ink printed on the workpiece 20, then the rotary module 14 rotates the workpiece 20 such that the side of the workpiece 20 facing the printing module 13 can be switched between the second surface 22 and the side surface 23, therefore, the inkjet printing and curing process performed on the workpiece 20 by the printing module 13 is continuous, the workpiece 20 can be processed continuously on more than one sides.

It should be noted that the apparatus 10 can be arranged with one or more of the printing module 13, rotary module 14, and transporting module 15. The apparatus 10 illustrated in FIG. 2 is arranged with two printing modules 13, two rotary modules 14, and two transporting modules 15 to perform inkjet printing and curing process on two workpieces 20 synchronously.

According to a further embodiment, the supporting module 12 comprises a frame 121, a first driver 122, and a guider 123, wherein the frame 121 is mounted on the base 11, the first driver 122 is connected to the guider 123, the guider 123 extends along the X axis and is provided on the frame 121, the printing module 13 is connected to the guider 123 for being driven by the first driver 122 to move along the guider 123.

According to a further embodiment, the guider 123 comprises a guide rail 1231 and a slider 1232, wherein the guide rail 1231 is mounted on the frame 121 and extends along the X axis the slider 1232 is driven by the first driver 122 to slide along the guide rail 1231 for moving the printing module 13 along the X axis.

Referring to FIG. 2, according to a further embodiment, the printing module 13 comprises a second driver 131, a printing element 132, and a curing device 133, wherein the printing element 132 is connected to the guider 123 through the second driver 131 for being driven to move along the Z axis and to spray ink on the second surface 22 and the side surface 23 of the workpiece 20, the curing device 133 is connected to the second driver 131 for being driven to move along the Z axis and to cure the ink on the workpiece 20. Therefore, the distance between the workpiece 20 and the printing element 132/curing device 133 along the Z axis can be regulated by the second driver 131.

According to a further embodiment, the printing element 132 comprises a control valve 1322 and a plurality of inkjet heads 1321 connected to the control valve 1322, each inkjet head 1321 is used for spraying inks of one color, the second surface 22 and the side surface 23 can be coated with gradient by controlling the spray time and the spray quantity of each inkjet head 1321 through the control valve 1322.

In this embodiment, the inkjet heads 1321 are mounted on the curing device 133 for being driven by the second driver 131, the control valve 1322 is arranged on the second driver 131 for controlling the inkjet heads 1321 by electrical connection.

According to a further embodiment, the plurality of inkjet heads 1321 are connected directly to inks with different colors. In operation, driven by the second driver 131, the inkjet head 1321 connected to ink of a first color sprays on the second surface 22 or the side surface 23 to form a foundation or primer, then the inkjet head 1321 connected to ink of a second color sprays on the foundation to form a tint or gradient of colors.

According to a further embodiment, the curing device 133 is a UV-emitting light, the light emitted travels along the Y axis for curing the ink on the workpiece 20.

Referring to FIG. 2, according to the embodiment, the apparatus 10 further comprises a calibrator 16 configured for acquiring image of the workpiece 20, the calibrator 16 is arranged on the second driver 131 and is electrically connected to the second driver 131 and the first driver 122, therefore, the second driver 131 and the first driver 122 can actuated by the calibrator 16 based on the acquired image.

According to a further embodiment, the calibrator 16 is configured as an image capturing element with primary image processing function, for example, the calibrator 16 compares the captured image with pre-stored standard image of corresponding position, then the calibrator 16 is moved by the second driver 13 and the first driver 122 along the X axis and the Z axis, respectively, to an appropriate image capturing position.

It should be understood that, the calibrator 16 can be any element with primary image processing function.

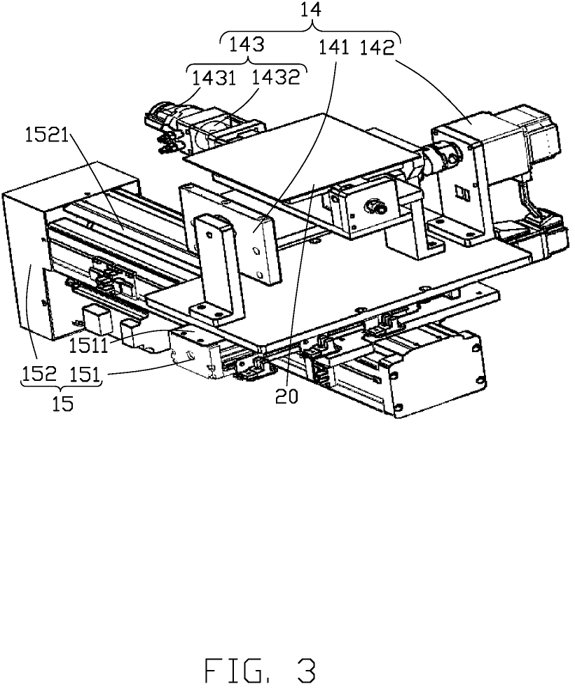

Referring to FIG. 3, according to a further embodiment, the rotary module 14 comprises a supporting base 141, a first rotating member 142 arranged on the supporting base 141, and a second rotating member 143 connected to the first rotating member 142, wherein the second rotating member 143 is configured for attaching the workpiece 20 by applying suction against the first surface 21 and rotating the workpiece 20 around the Y axis, the first rotating member 142 is configured for rotating the second rotating member 143 and the workpiece 20 thereon around the X axis.

According to a further embodiment, the second rotating member 143 comprises a motor 1431 and a suction element 1432 arranged on the motor 1431, wherein the suction element 1432 is connected to the motor 1431 for being driven to attach and rotate the attached workpiece 20 by suction force, the second rotating member 143 is connected to the first rotating member 142 through the motor 1431.

According to a further embodiment, the suction element 1432 is configured as a vacuum suction element, the first rotating member 142 and the motor 1431 are both servo motors.

According to a further embodiment, the transporting module 15 comprises a third driver 151 and a fourth driver 152 arranged on the base 11, wherein the supporting base 141 is mounted on the third driver 151 for being driven to move along the X axis, the third driver 151 is arranged on the fourth driver 152 for being driven to move along the Y axis.

According to a further embodiment, the third driver 151 is configured with a first rail 1511, the supporting base 141 is mounted on the third driver 151 through the first rail 1511, the fourth driver 152 is configured with a second rail 1521, the third driver 151 is arranged on the fourth driver 152 through the second rail 1521.

According to a further embodiment, the third driver 151 and the fourth driver 152 are both servo motors.

It should be noted that, the calibrator 16 can be connected to all of the second driver 131, the first driver 122, the first rotating member 142, the motor 1431, and the fourth driver 152, for being moved along the X axis, the s Z axis, and the Y axis.

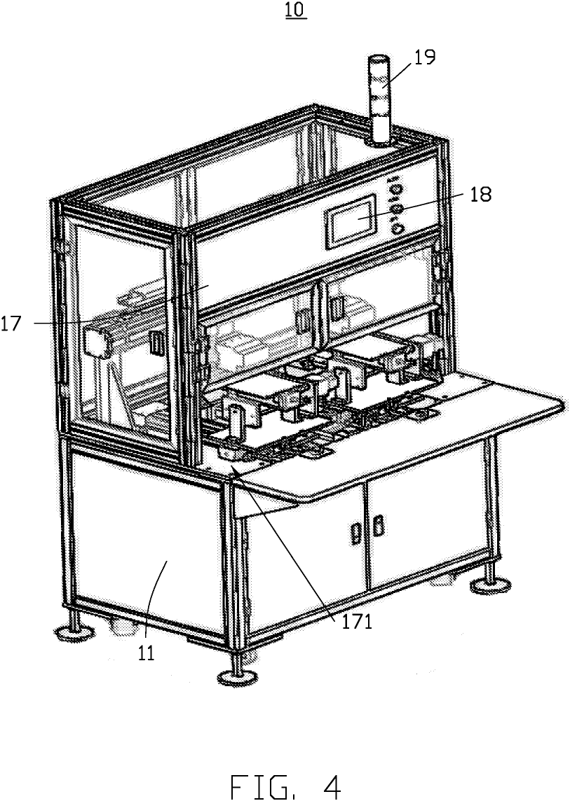

Referring to FIG. 4, according to a further embodiment, the apparatus 10 comprises a shell 17 arranged on the base 11, the supporting module 12 and the printing module 13 are received in the shell 17, the shell 17 is configured with an opening 171 for passage of the workpiece 20.

According to a further embodiment, the shell 17 is configured with a cavity for receiving the supporting module 12 and the printing module 13, therefore the inkjet printing and curing operations are performed in the cavity to avoid escape of or contamination by the ink from the printing module 13.

According to a further embodiment, the apparatus 10 comprises a displayer 18 arranged on the shell and a signal light 19, the displayer 18 is connected to the printing module 13, the rotary module 14, and the transporting module 15 for displaying processing information of the workpiece 20, the signal light 19 is connected to the printing module 13, the rotary module 14, and the transporting module 15 for indicating processing phase of the workpiece 20.

According to a further embodiment, the processing information of the workpiece 20 comprises at least one of the spray time, incline angle, the spraying position of the inkjet head, and any other data relevant to the inkjet printing and curing processes.

According to a further embodiment, the processing phase of the workpiece 20 comprises phase of processing, phase of waiting, and phase of completion, the signal light 19 comprises a 3-colored LED lights: red, yellow, and green. In operation, when the workpiece 20 is in the phase of under process, the signal light 19 is red, when the workpiece 20 is in the phase of waiting, the signal light 19 is yellow, when the workpiece 20 is in the phase of being completed, the signal light 19 is green. Therefore, the signal light 19 indicates processing phase of the workpiece 20.

According to a further embodiment, the displayer 18 is a touch screen, which facilitates operation of workers.

Referring to FIGS. 1-4, the process of the operation of the apparatus 10 is as follows:

Firstly, the workpiece 20 is attached to the suction element 1432 via the first surface 21, for being rotated by the first rotating member 142 and the motor 1431 such that the second surface 22 face upwards, then the workpiece 20 is moved by the third driver 151 and the fourth driver 152 through the opening 171 to be under the inkjet head 1321 of the printing element 132, and the calibrator 16 regulates the position of the workpiece 20.

Secondly, the control valve 1322 actuates the inkjet head 1321 and the curing device 133 to spray inks to the second surface 22 according to a pre-designed pattern and emits UV light to the ink on the second surface 22 for curing. After the ink is cured, the workpiece 20 is rotated by 90° around the X axis by the first rotating member 142 and the motor 1431, such that one of the side surfaces 23 of the workpiece 20 faces the inkjet head 1321 for being sprayed and cured. After that, the workpiece 20 is rotated back to its original orientation and further rotated by 90° around the X axis, such that another side surface 23 of the workpiece 20 faces the inkjet head 1321 for being sprayed and cured.

At last, similarly, the workpiece 20 is rotated around the Y axis by the motor 1431 and sprayed and cured, such that remaining two side surfaces 23 of the workpiece 20 can be sprayed and cured.

It should be noted that, during the printing process mentioned above, the spraying orders and spraying time of each inkjet head is controlled by the control valve 1322 to form gradient on the second surface 22 and the side surfaces 23.

It should be noted that, in further embodiments, the workpiece 20 can be made of other materials, such as wrought magnesium alloy, casting magnesium alloy, aluminum alloys, glasses, or any other material suitable for shells of electronic devices.

While the invention has been described in detail in connection with only a limited number of embodiments, it should be readily understood for the skilled in the art that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An apparatus for inkjet printing and curing integration process, which performs a continuous inkjet printing and curing process on more than one side of a workpiece, wherein
the workpiece shaped as a cube configured with a first surface, a second surface opposite to the first surface, and more than one side surfaces connected between the first surface and the second surface;
the apparatus comprises:
a base,
a supporting module arranged on the base,
a printing module mounted on the supporting module, the printing module slides on the supporting module along a X axis, sprays ink along a Z axis on the second surface and the side surfaces of the workpiece, and cures the ink sprayed on the workpiece,
a rotary module positioned relative to the printing module, the rotary module is configured for rotating the workpiece to present more than one side of the workpiece to face the printing module between the second surface and the side surfaces; and
a transporting module arranged on the base, the transporting module moves along the X axis and a Y axis, the rotary module is connected to the transporting module for moving with it; wherein
each two of the X axis, the Y axis and the Z axis are perpendicular to each other.

2. The apparatus for inkjet printing and curing integration process of claim 1, wherein the supporting module comprises
a frame mounted on the base;
a guider provided on the frame, the guider extends along the X axis; and
a first driver connected to the guider; wherein
the printing module is connected to the guider for being driven by the first driver to move along the guider.

3. The apparatus for inkjet printing and curing integration process of claim 2, wherein the printing module comprises
a second driver connected to the guider;
a printing element connected to the second driver, for being driven to spray ink on the second surface and the side surface of the workpiece;
a curing device connected to the second driver, for curing the ink on the workpiece; wherein
the second driver drives the printing element and the curing device to move along the Z axis.

4. The apparatus for inkjet printing and curing integration process of claim 3, wherein the printing element comprises
a plurality of inkjet heads, each inkjet head is used for spraying inks of one color;
a plurality of control valves, each of the control valves is connected to one of the inkjet heads for controlling the spray time and the spray quantity of the connected inkjet head, to coat the second surface or the side surface with gradient.

5. The apparatus for inkjet printing and curing integration process of claim 3, further comprises
a calibrator configured for acquiring image of the workpiece, the calibrator is electrically connected to the second driver and the first driver for actuating the second driver and the first driver according to the acquired image.

6. The apparatus for inkjet printing and curing integration process of claim 1, wherein the rotary module comprises
a supporting base;
a first rotating member arranged on the supporting base; and
a second rotating member configured for attaching the workpiece by the vacuumattraction of the first surface, wherein
the first rotating member is connected to the second rotating member for rotating the second rotating member and the workpiece thereon around the X axis, the second rotating member is configured for rotating the workpiece around the Y axis.

7. The apparatus for inkjet printing and curing integration process of claim 6, wherein the second rotating member comprises
a motor and a suction element connected to the motor, wherein
the suction element is connected to the motor for creating a vacuum for attaching and rotating the attached workpiece, the second rotating member is connected to the first rotating member through the motor.

8. The apparatus for inkjet printing and curing integration process of claim 1, wherein the transporting module comprises
a third driver and a fourth driver arranged on the base, the supporting base is mounted on the third driver for being driven to move along the X axis, the third driver is arranged on the fourth driver for being driven to move along the Y axis.

9. The apparatus for inkjet printing and curing integration process of claim 1, further comprises
a shell configured for receiving the supporting module and the printing module, the shell is arranged on the base and is configured with an opening for passage of the workpiece.

10. The apparatus for inkjet printing and curing integration process of claim 9, further comprises
a displayer arranged on the shell, the displayer is connected to the printing module, the rotary module, and the transporting module for displaying processing information of the workpiece; and
a signal light connected to the printing module, the rotary module, and the transporting module for indicating processing phase of the workpiece.

11. The apparatus for inkjet printing and curing integration process of claim 1, wherein the apparatus can be used for printing on magnesium alloys, aluminum alloys, glasses, and other materials suitable for shells of electronical devices.
